(19) United States
(12) Patent Application Publication
(10) Pub. No.: US 2008/0128586 A1
(43) Pub. Date: Jun. 5, 2008

(54) Sun sensor assembly and related method of using

(76) Inventors: Richard L. Johnson, Suffolk, VA (US); Braden E. Hines, Pasadena, CA (US); Philip C. Irwin, Sierra Madre, CA (US); Benjamin McLaughlin Gallant, San Francisco, CA (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/974,407

(22) Filed: Oct. 12, 2007

Related U.S. Application Data
(60) Provisional application No. 60/851,572, filed on Oct. 13, 2006.

(51) Int. Cl. G01J 1/20; G01J 1/42

(52) U.S. Cl. 250/203.4; 250/208.2

(57) ABSTRACT

The present invention includes a sun sensor assembly having an aperture that defines an area that is less than the area of the photo-detecting surface of a corresponding first photo-detector. According to another aspect, the present invention also includes a solar concentrator includes at least two sun sensor assemblies mounted on the concentrator in a manner to help the solar concentrator track the sun. According to another aspect, the present invention also includes a method of processing electrical signals from two or more photo-detectors. According to yet another aspect, the present invention includes a sun tracking system that includes a solar panel that includes a solar concentrator and control system.

### PRIORITY

The present non-provisional patent application claims benefit from U.S. Provisional Patent Application having Ser. No. 60/851,572, filed on Oct. 13, 2006, and titled Sensor Apparatus, Methods of Production and Uses Thereof, wherein the entirety of said provisional patent application is incorporated herein by reference.

### FIELD OF THE INVENTION

The present invention relates to sun sensor assemblies and related solar concentrators and solar panels. The present invention also relates to methods of processing electrical signals from two or more photo-detectors.

### BACKGROUND

Commonly-owned U.S. Pub. Nos. 2006/0283497 (Hines) and 2007/0193620 (Hines et al.), the entireties of which are incorporated herein by reference, disclose optical concentrating systems and methods by which solar energy may be concentrated onto photovoltaic cells using one and two axis sun tracking modules. These systems include a mechanism by which to sense the relative position of the sun using one or more sun sensing devices and effect articulation of these modules using one or more actuating devices.

U.S. Pat. No. 4,349,733 (Beam et al.) discloses a sun tracker for use on a sun following device such as a concentrating solar collector. The sun tracker includes two spaced apart photosensitive elements which are separated by an opaque splitter plate so that when the splitter plate points directly at the sun the photosensitive devices are uniformly excited.

U.S. Pat. No. 4,495,408 (Mori) discloses a sunlight direction sensor having a cylindrical body, a nontransparent flange having a diameter smaller than the inner diameter of the cylindrical body, a first photosensor disposed on the flange or substantially at the center of the inner bottom surface of the cylindrical body, and at least one pair of second and third photosensors which are disposed at the inner bottom surface of the cylindrical body and which are arranged symmetrically with respect to the axis of the cylindrical body, inner edges of the second and third photosensors corresponding to the inner periphery of the flange.

U.S. Pat. No. 4,320,288 (Schlarlack) discloses a dual mode solar tracking method and system in which a sensor of radiation from the sun normally tracks the sun at a rate determined by a priori information, departure from normal tracking and correction for tracking rate errors being introduced only when the errors exceed a predetermined value and the strength of radiation from the sun exceeds a predetermined threshold value.

U.S. Pat. No. 4,146,785 (Neale) discloses a solid-state control system for the control of a collector array, the system incorporating a sun-tracking mode, de-focusing at excessive temperatures, returning to a stand-by position after sunset, and prepositioning at sunrise.

U.S. Pat. No. 4,107,521 (Winders) discloses a solar sensor and tracker apparatus in which an extremely low cost high angular accuracy sensor and tracking device utilizing a symmetrical sensor shade and sensor arrangement is described. Also, a circuit control for electric motor drive of the tracker apparatus is also described in which a relatively high speed track operation followed by a relatively slow speed homing in motion is automatically provided by the control circuit driving the electric motors.

U.S. Pat. No. 4,262,195 (White et al.) discloses a solar tracker for a solar collector which is angularly oriented by a motor wherein the outputs of two side-by-side photodetectors are discriminated as to three ranges, a first corresponding to a low light or darkness condition; a second corresponding to light intensity lying in an intermediate range; and a third corresponding to light above an intermediate range, direct sunlight. The first output drives the motor to a selected maximum easterly angular position; the second enables the motor to be driven westerly at the earth rotational rate; and the third output, the separate outputs of the two photodetectors, differentially controls the direction of rotation of the motor to effect actual tracking of the sun.

A deficiency with many prior art sun sensor assemblies is that the photo-detecting surfaces of the photo-detectors are not uniformly positioned among multiple sun sensor assemblies (e.g., within a lot and/or among lot to lot). While other sun sensor assemblies may be fairly consistent with respect to photo-detector positioning among multiple sun sensor assemblies, such assemblies often require time consuming and costly procedures for proper positioning and even then such assemblies often do not account for variations in the photo-detectors themselves (e.g., undue variation of photo-detector size such as diameter). Unfortunately, a lack of proper positioning of such photo-detectors can impact tracking performance of a sun sensor assembly to an undue degree. Accordingly, a need exists to provide a sun sensor assembly that can be manufactured in high volume and at low cost, while still maintaining a high level of sun detecting accuracy.

In addition, a deficiency of many sun tracking systems is that each signal from a photo-detector is processed by an individual detection circuit such that the system does not account for bias sources such as mismatch among the components of these detection circuits, thermal drift, and/or drift associated with component lifetime. Unfortunately, not accounting for such bias sources can lead to erroneous detection signals with respect to the location of the sun. Accordingly, a need exists to provide photo-detector signal processing methods that can eliminate one or more sources of bias.

### SUMMARY OF THE INVENTION

The present invention provides a sun sensor assembly that includes one or more apertures to define an area of corresponding photo-detectors in a uniform and consistent manner among sun sensor assembly to sun sensor assembly. Advantageously, such sun sensor assemblies can be produced in high volume and at low cost while maintaining a level of precision and accuracy sufficient for high concentration solar collectors and systems.

In addition, the present invention provides control systems and method of processing electrical signals from two or more photo-detectors that select a signal before further downstream processing (e.g., by a microprocessor) which is also referred to as common signal processing chains. Advantageously, such methods can minimize sensing errors from bias sources such as component mismatching, thermal drift, and/or drift associated with component lifetime.

According to one aspect of the present invention, a sun sensor assembly includes a first photo-detector and a second photo-detector, a base, and a light blocking member. Each photo-detector has a photo-detecting surface. The base has a first surface that includes a first aperture and a second aperture. The first aperture defines an area that is less than the area of the photo-detecting surface of the first photo-detector. The second aperture defines an area that is less than the area of the photo-detecting surface of the second photo-detector. The first photo-detector is positioned in a manner such that the first aperture overlies the photo-detecting surface of the first photo-detector in a manner so as to expose a portion of the photo-detecting surface to incident sun-light. The second photo-detector is positioned in a manner such that the second aperture overlies the photo-detecting surface of the second photo-detector in a manner so as to expose a portion of the photo-detecting surface to incident sun-light. The light blocking member is positioned on the first surface of the base in a manner that allows an illumination source to differentially illuminate the first and second photo-detectors as a function of the angle between the illumination source and a normal vector of the photo-detecting surfaces.

According to another aspect of the present invention, a solar concentrator includes at least two sun sensor assemblies mounted on the concentrator in a manner to help the solar concentrator track the sun. The at least two sun sensor assemblies each include a first photo-detector and a second photo-detector, a base, and a light blocking member. Each photo-detector has a photo-detecting surface. The base has a first surface that includes a first aperture and a second aperture. The first photo-detector is positioned in a manner such that the first aperture overlies the photo-detecting surface of the first photo-detector in a manner so as to expose a portion of the photo-detecting surface to incident sun-light. The second photo-detector is positioned in a manner such that the second aperture overlies the photo-detecting surface of the second photo-detector in a manner so as to expose a portion of the photo-detecting surface to incident sun-light. The light blocking member positioned on the first surface of the base in a manner that allows an illumination source to differentially illuminate the first and second photo-detectors as a function of the angle between the illumination source and a normal vector of the photo-detecting surfaces.

According to another aspect of the present invention, a method of processing electrical signals from two or more photo-detectors includes providing two or more photo-detectors that generate an electrical signal indicative of the amount of incident light upon the photo-detector, selecting one electrical signal from among the electrical signals generated by the two or more photo-detectors, and conditioning the selected electrical signal in a manner so as to provide an unbiased electrical signal.

According to another aspect of the present invention, a sun tracking system includes a solar panel that includes a solar concentrator positioned on the solar panel in a manner sufficient to track the sun along an axis and a sun sensor assembly positioned on the solar concentrator in a manner sufficient to track the sun along an axis. The sun sensor assembly includes at least two photo-detectors and a control system. Each photo-detector generates an electrical signal indicative of the amount of incident light upon each respective photo-detector. The control system is in electrical communication with the solar panel such that the control system can receive and send electrical signals in a manner to help the at least one solar concentrator track the sun. The control system includes program instructions that include selecting one electrical signal from among the electrical signals generated by the at least two photo-detectors and conditioning the selected electrical signal in a manner so as to provide an unbiased electrical signal.

### BRIEF DESCRIPTION OF THE DRAWINGS

FIG. 1 shows a top view of a sun sensor assembly according to the present invention.

FIG. 2 shows a cross-sectional view of the sun sensor assembly shown in FIG. 1 along line 2-2.

FIGS. 3A and 3B show a close-up view of the narrow angle sensor shown in FIG. 2.

FIG. 4 shows a close-up top view of the narrow angle sensor shown in FIG. 1.

FIG. 5 shows a cross-sectional view of the narrow angle sensor shown in FIG. 4 along line 5-5.

FIG. 6 shows an end view of a solar concentrator that includes two sun sensor assemblies, wherein each sun sensor assembly is shown in FIG. 1.

FIG. 7A shows a cross-sectional view of the solar concentrator shown in FIG. 6 along line 7A-7A.

FIG. 7B shows a close up view of a sun sensor assembly shown in FIG. 7A.

FIG. 8A shows a perspective view of the solar concentrator shown in FIG. 6 with a portion of a sun sensor assembly shown in cross-section.

FIG. 8B shows a close up view of the narrow angle sensor shown in FIG. 8A.

FIG. 8C shows a close up view of the wide angle sensor shown in FIG. 8C.

FIG. 9 shows a top view of a concentrator panel that includes a plurality of the solar concentrator shown in FIG. 6.

FIG. 10 shows a cross-sectional view of an alternative narrow angle sensor according to the present invention.

FIG. 11 shows a perspective view of an alternative sun sensor assembly according to the present invention.

FIG. 12 shows an exploded view of the sun sensor assembly shown in FIG. 11.

FIG. 13 shows another exploded view of the sun sensor assembly shown in FIG. 11 with the photo-detectors removed.

FIG. 14 shows a cross-sectional view of the sun sensor assembly shown in FIG. 11.

FIG. 15 shows the cross-sectional view shown in FIG. 14 with other items identified.

FIG. 16A shows the cross-sectional view shown in FIG. 14 with other items identified.

FIG. 16B shows a cross-sectional view of the sun sensor assembly in FIG. 16A along line 16B-16B.

FIG. 16C shows a cross-sectional view of the sun sensor assembly in FIG. 16A along line 16C-16C.

FIG. 16D shows a cross-sectional view of the sun sensor assembly in FIG. 16A along line 16D-16D.

FIG. 16E shows a cross-sectional view of the sun sensor assembly in FIG. 16A along line 16E-16E.

FIG. 16F shows a cross-sectional view of the sun sensor assembly in FIG. 16A along line 16F-16F.

FIG. 17 shows a block diagram describing a method of sun tracking according to the present invention.

FIG. 18 shows a plot of photocurrent versus angle in connection with the narrow angle sensor of FIG. 10 generating no sensing error.

FIG. 19 shows a plot of photocurrent versus angle in connection with the narrow angle sensor of FIG. 10 generating sensing error.

### DETAILED DESCRIPTION

Numerous solutions are provided herein that are helpful, either singly or in combination, to overcome and/or alleviate one or more of the problems present in the prior art. To these ends, sun tracking apparatus are described herein that include one or more wide angle sensors and/or one or more narrow angle sensors. Additionally, sun tracking methods are described herein that include one or more common signal chains, a microprocessor-based control system, one or more redundant sun sensors, a mechanism to effect articulation, and/or a self-calibration process.

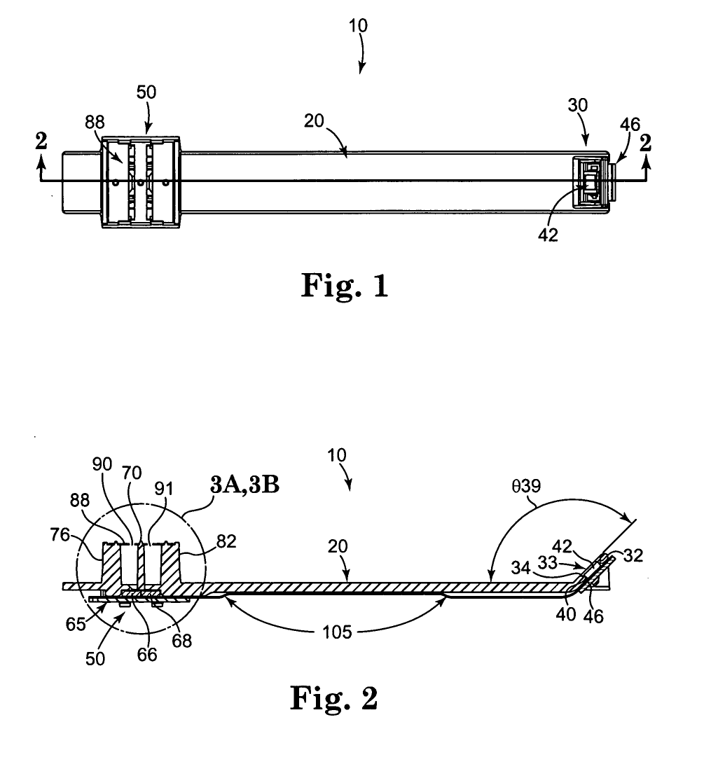

One aspect of the present invention relates to sun sensor assemblies. One embodiment of a sun sensor assembly 10 according to the present invention is described in connection with FIGS. 1-9. As shown, sun sensor assembly 10 has a base 20, a wide angle sensor 30, a narrow angle sensor 50, and a circuit 105.

As shown in FIG. 1, base 20 is generally planar and rectangular in shape. Base 20 provides structure and support for one or more additional structures or components of a sun sensor assembly. Base 20 can be a separate structure to which the other structure(s) and/or component(s) are fastened to and/or base 20 can form a unitary structure with one or more structure(s) and/or component(s).

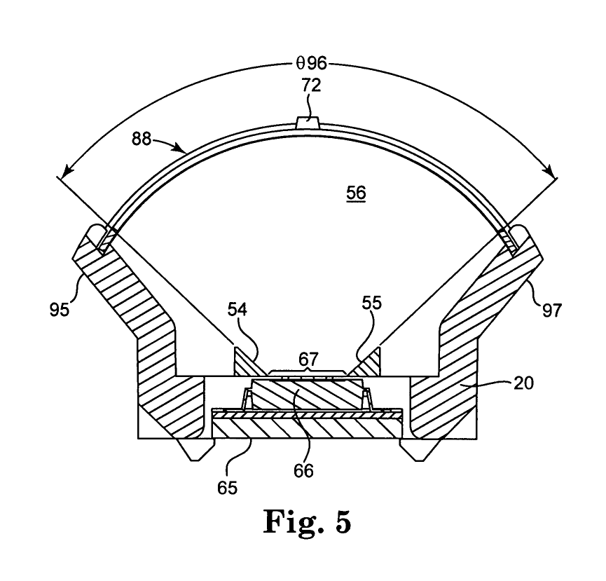

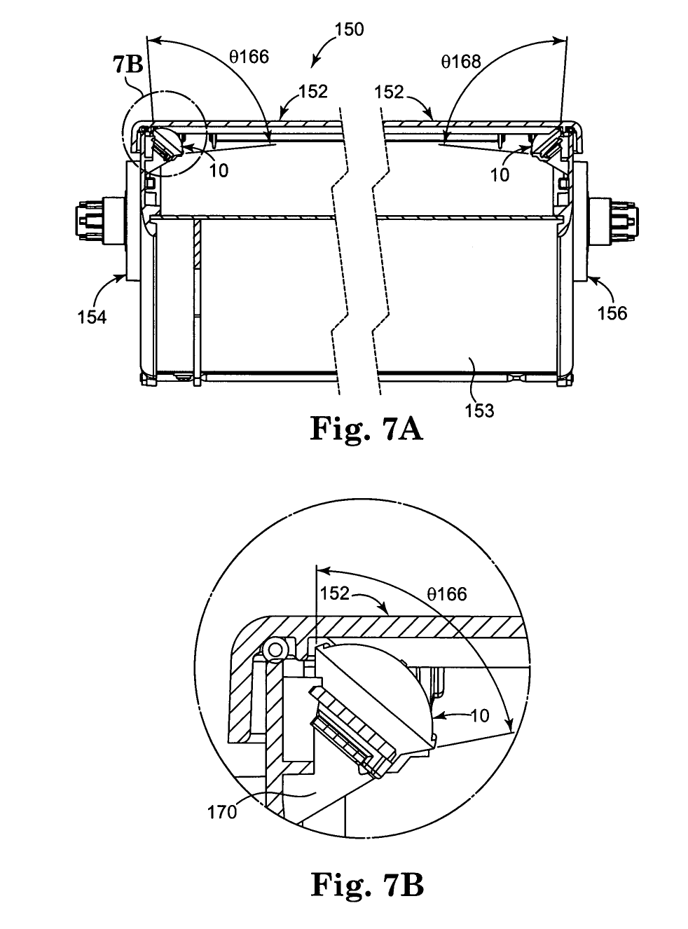

Wide angle sensor 30 has a field of view such that sensor 30 can be used with one or more additional wide angle sensor(s) 30 to coarsely track the sun (e.g., see FIGS. 7A and 7B which show two sensors 30 that provide a combined field of view of 180 degrees). At least two wide angle sensors 30 allow a differential signal to be generated among the two or more sensors 30 and be used by any well-known tracking method to coarsely track the sun. Wide angle sensor 30 generally has a larger field of view than a narrow angle sensor (e.g., sensor 50). As used herein, the field of view of a sun sensor (narrow angle sensor or wide angle sensor) refers to the angular extent to which active photo-detecting surface can detect light as measured from the active photo-detecting surface. For example, as discussed in below in connection with FIG. 5, the angle θ₉₆ defines the field of view of active area window 67 in the non-tracking axis. In preferred embodiments, wide angle sensor 30 has a field of view of 45 degrees (+/−22.5 degrees) or greater, preferably 90 degrees (+/−45 degrees) or greater. As shown in sun sensor assembly 10, wide angle sensor 30 has a field of view of +/−45 degrees. As shown, wide angle sensor 30 includes angled support 32, photo-detector 42, and printed circuit board 46. Support 32 includes a slot 40 that has a beveled lip 34 and provides support structure for photo-detector 42. With photo-detector 42 in position as shown, support 32 has an aperture 33 through which light can be detected by photo-detector 42. Support 32 is positioned relative to base 20 in a manner that helps photo-detector 42 of sensor 30 coarsely track the sun. As shown in FIG. 2, support 32 is angled towards narrow angle sensor 50 and positioned relative to base 20 such that an angle θ₃₉ is between the photo-detecting surface of photo-detector 42 and base 20. In preferred embodiments angle θ₃₉ is an angle greater than 90 degrees, preferably an angle greater than 115 degrees. For example, angle θ₃₉ can an angle in the range from 110 to 180 degrees, preferably from 120 to 160 degrees, and even more preferably from 130 to 140 degrees. As can be seen in FIG. 2, angled support 32 is an integrally formed part of base 20. However, support 32 could be separately formed from base 20 and fastened to base 20 in any suitable manner.

Photo-detector 42 is attached to printed circuit board 46. Photo-detector 42 can be any such detector useful for producing a voltage and supplying a current when illuminated. Exemplary photo-detectors can be commercially obtained under the trade name QSB34 from Fairchild Semiconductor Corporation, South Portland, Me. QSB34 photodiodes are surface mount silicon pin photodiodes having dimensions of approximately 5 millimeters by 5 millimeters. Printed circuit board 46 can be any printed circuit board for mechanically supporting and electrically connecting electrical components. Printed circuit boards are well known.

Narrow angle sensor 50 has a field of view such that sensor 50 can be used to finely track the sun. Narrow angle sensor 50 generally has a smaller field of view than a wide angle sensor (e.g., sensor 30) and can preferably reject scattered radiation from the sky or other objects (e.g., buildings) that could otherwise reduce the accuracy of sun sensor assembly 10. As described below, the field of view of a narrow angle sensor can be “narrowed” by including structure (e.g., one or more of blinders/light blocking members, sloping shoulders, and the like) that can block light from being incident upon the photo-detecting surface of a photo-detector. In preferred embodiments, narrow angle sensor 50 has a field of view of +/−20 degrees or less, even more preferably +/−15 degrees or less, and yet even more preferably +/−10 degrees or less. As shown, narrow angle sensor 50 has a field of view of +/−15 degrees.

As shown, narrow angle sensor 50 includes photo-detectors 66 and 68, printed circuit board 65, apertures 52 and 58, slot 64, blinders 70, 76, and 82, walls 95 and 97, mask 88, and clips 100 and 102.

Photo-detectors 66 and 68 are attached to printed circuit board 65. Photo-detectors 66 and 68 can be any detector useful for producing a voltage and supplying a current when illuminated. Exemplary photo-detectors can be commercially obtained under the trade name QSB34 from Fairchild Semiconductor Corporation, South Portland, Me. QSB34 photodiodes are surface mount silicon pin photodiodes having dimensions of approximately 5 millimeters by 5 millimeters.

Printed circuit board 65, as discussed above with respect to printed circuit board 46, can be any printed circuit board for mechanically supporting and electrically connecting electrical components. As shown in FIG. 2, printed circuit boards 46 and 65 are electrically connected via circuit 105. In preferred embodiments, circuit 105 is a flex circuit.

Apertures 52 and 58 are openings through which light can pass and illuminate photo-detectors 66 and 68, respectively, so that photo-detectors 66 and 68 can be used to help track the sun. As shown, aperture 52 is defined by sloping shoulders 53, 54, and 55, and wall 56 of blinder 70. In a similar manner, aperture 58 is defined by sloping shoulders 60, 61, and 62, and wall 56 of blinder 70.

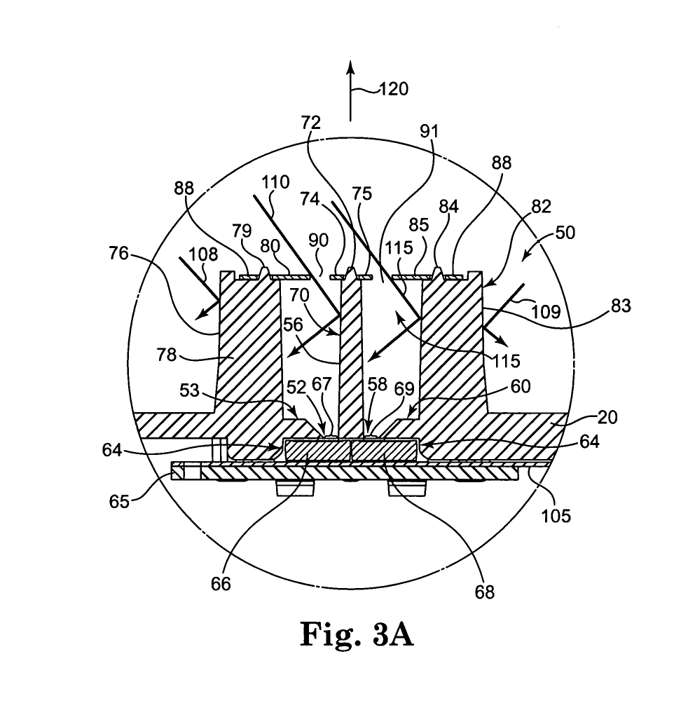

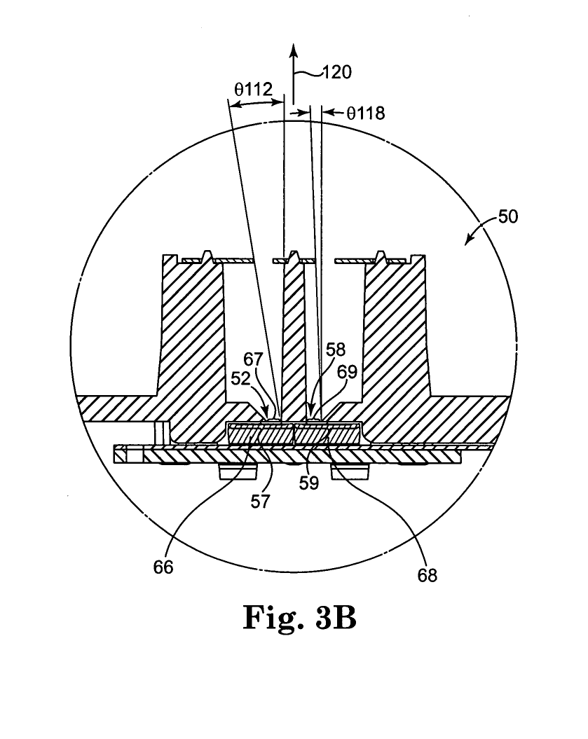

Slot 64 provides support structure for photo-detectors 66 and 68. Slot 64 is positioned in a manner so as to register photo-detectors 66 and 68 with respect to apertures 52 and 58, respectively. As can be seen in FIGS. 3A and 3B, aperture 52 defines an area that is less than the area of photo-detecting surface 57 of the photo-detector 66 such that when photo-detector 66 is positioned in slot 64, aperture 52 overlies the photo-detecting surface 57 such that a portion 67 of the photo-detecting surface 57 is defined that can be exposed to incident sunlight. The portion 67 of photo-detecting surface 57 that can be exposed to incident sunlight is also referred to “active area window” 67. In preferred embodiments, as shown, the area defined by aperture 52 is within the boundaries (i.e., does not touch the boundaries) of photo-detecting surface 57. In a similar manner, aperture 58 defines an area that is less than the area of photo-detecting surface 59 of the photo-detector 68 such that when photo-detector 68 is positioned in slot 64, aperture 58 overlies the photo-detecting surface 59 of photo-detector 68 so that a portion 69 of the photo-detecting surface 59 of photo-detector 68 can be exposed to incident sunlight. The portion 69 of the photo-detecting surface 59 of photo-detector 68 that can be exposed to incident sunlight is also referred to “active area window” 69. In preferred embodiments, as shown, the area defined by aperture 58 is within the boundaries (i.e., does not touch the boundaries) of photo-detecting surface 59. Advantageously, using apertures 52 and 58, and slot 64 together so as to define active area windows 67 and 69, respectively, allows sun sensor assembly 10 to be mass produced at low cost, while at the same time maintaining a high level of precision and accuracy for concentrating solar collectors and systems. For example, photo-detectors 66 and 68 may have variations in the diameters of photo-detecting surfaces 57 and 59, respectively, due to manufacturing tolerances. Undue variation among the diameters of photo-detectors during mass production of a sun sensor can cause variation in the distance from a photo-detector center to other sensor features (e.g., one or more of walls 56, wall 78, and wall 83), which can otherwise reduce the pointing accuracy of a narrow angle sensor. However, using apertures (e.g., apertures 52 and 58) that are sufficiently under-sized relative to the photo-detecting surfaces (e.g., photo-detecting surfaces 57 and 59) of photo-detectors, active area windows (e.g., active area windows 67 and 69) can be defined that provide photo-detecting surfaces in positions that are sufficiently consistent/uniform among multiple sun sensor assemblies that are mass produced. For example, in preferred embodiments apertures (e.g., apertures 52 and 58) are positioned relative to other sun sensor features in a uniform manner among sun sensor assemblies that are mass produced (e.g., within a lot of sun sensor assemblies and/or among lot to lot of sun sensor assemblies), especially sun sensor features that impact the pointing accuracy of the sun sensor (e.g., one or more of walls 56, wall 78, and wall 83).

Blinders 70, 76, and 82 are light blocking members, which include wall-like structures used to block light at a given angle from being incident upon a photo-detector, especially in connection with a narrow angle sensor.

Blinder 70 is positioned in a manner that differentially illuminates the active area windows 67 and 69 of photo-detectors 66 and 68, respectively, as a function of the angle between an illumination source (e.g., the sun) and the normal vector 120 of the active area windows 67 and 69. As shown, blinder 70 preferably includes wall 56 and ledges 74 and 75. Ledges 74 and 75 are part of mask 88 (mask 88 discussed below). In alternative embodiments blinder 70 could include wall 56 without ledges 74 and 75. With respect to finely tracking the sun, when blinder 70 is pointed directly towards the sun ledges 74 and 75 partially shade active area windows 67 and 69, respectively, yet active area windows 67 and 69 receive substantially equal illumination from the sun, thereby indicating that the sun sensor 50 (and any properly oriented and associated components) is pointed directly at the sun. As the sun moves off center from blinder 70 towards active area window 69, wall 56 and ledge 74 will shade active area window 67 more and active area window 69 will be more illuminated (i.e., windows 67 and 69 will be differentially illuminated), thereby indicating that the sun has moved and that sun sensor 50 (and any properly oriented and associated components) is not pointed directly at the sun.

Wall 56 includes a protrusion 72 to register mask 88 into position. In preferred embodiments, as shown, wall 56 forms a unitary structure with base 20. However, wall 56 could be a separate component from base 20 and fastened to base 20 in any suitable manner.

Blinders 76 and 82 help define the field of view of active area windows 67 and 69. As shown, blinder 76 includes wall 78 and ledge 80. Blinder 76 further defines (i.e., reduces/narrows) the field of view of active area window 67 by rejecting scattered radiation 108 from the sky or other objects (e.g., buildings) that could cause active area window 67 of photo-detector 66 to generate inaccurate signals as to the location of the sun. As shown, blinder 82 includes wall 83 and ledge 85. Similar to blinder 76, blinder 82 further defines (i.e., reduces/narrows) the field of view of active area window 69 by rejecting scattered radiation 109 from the sky or other objects (e.g., buildings) that could cause active area window 69 to generate inaccurate signals as to the location of the sun.

Similar to ledges 74 and 75, ledges 80 and 85 are part of mask 88. Similar to wall 56, each of walls 78 and 83 include protrusions 79 and 84, respectively, to register mask 88 into position. In preferred embodiments, as shown, walls 78 and 83 form a unitary structure with base 20. However, one or more of walls 78 and 83 could be a separate component from base 20 and fastened to base 20 in any suitable manner.

As shown in FIG. 5, narrow angle sensor 50 includes walls 95 and 97 that extend between walls 56 and 78. Similar to walls 95 and 97, a pair of walls (not shown) extend between walls 56 and 83.

Mask 88 is an opaque cover positioned on top of walls 56, 78, and 83, and is registered in place via protrusions 72, 79, and 84, respectively. As described above, ledges 74, 75, 80 and 85 are part of mask 88 and help define the field of view of active area windows 67 and 69. Mask 88 reduces the field of view of active area windows 67 and 69 in the tracking axis by including slits 90 and 91, respectively. Slit 90 forms ledges 74 and 80 and slit 91 forms ledges 75 and 85. As shown in FIG. 5, mask 88 has an arcuate or semi-cylindrical type shape thereby providing a field of view corresponding to angle θ₉₆ for active area windows 67 and 69 in the non-tracking axis. For example, when narrow angle sensor 50 is used as an east-west tracking sensor blinders 70, 76, and 82, are generally aligned along a north-south line. The semi-cylindrical shape of mask 88 allows the distance from the slits 90 and 91 in mask 88 to the active area windows 67 and 69, respectively, to be the same for all sun angles measured north-south. Advantageously, the sensor 50 can have the same sensitivity in the winter when the sun is low in the sky and in the summer when the sun is high in sky.

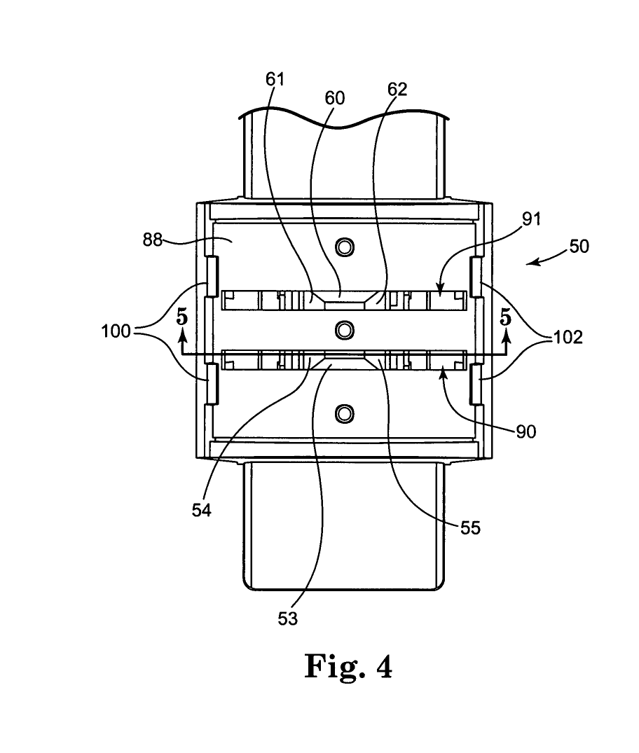

As shown in FIG. 4, mask 88 is seen to be held into place by clips 100 and 102. In preferred embodiments, as shown, clips 100 and 102 form a unitary structure with base 20.

Overall, the field of view of the narrow angle sensor 50 is defined by the field of view of active area windows 67 and 69 and blinders 70, 76, and 82. For example, as shown in FIGS. 3A and 3B, as light ray 110 pass through slit 90 of mask 88 at an angle greater than θ₁₁₂, light ray 110 impinges on wall 56 of blinder 70 and is not detected by active area window 67 of photo-detector 66. As light ray 115 passes through slit 91 of mask 88 at an angle greater than θ₁₁₈, light ray 115 impinges on wall 83 of blinder 82 or sloping shoulder 60 and is not detected by active area window 69 of photo-detector 68. As such, the field of view of each of the active area windows 67 and 69 is asymmetric relative to the normal 120 in that active area window 67 of photo-detector 66 can detect light rays within θ₁₁₂ degrees from one side of normal 120 but can only detect light rays within θ₁₁₈ degrees from the other side of normal 120. The converse is true for active area 69 of photo-detector 68. The field of view for the narrow angle sensor 50 as a whole is 2θ₁₁₂.

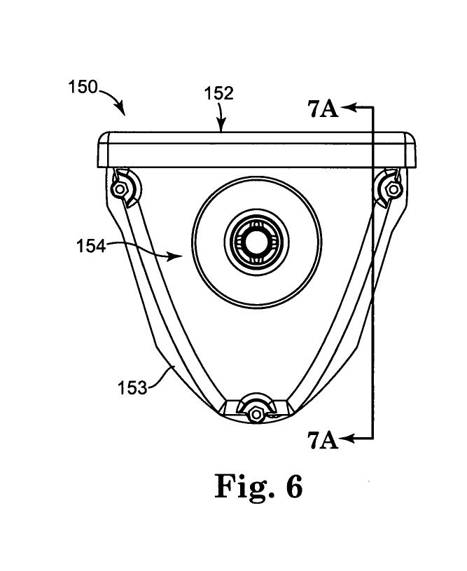

Optionally, a sun sensor assembly of the present invention can be encapsulated with a protective layer. Advantageously, encapsulating a sun sensor assembly protects the assembly from the environment, provides a mechanism by which to co-articulate the sun sensor assembly with other components (e.g., solar concentrator), and/or does not affect the articulation range of the solar concentrator (e.g., trough concentrator). A sun sensor assembly according to the present invention can be encapsulated by any method that protects sensitive components from the elements (rain, debris, and the like), yet allows the light sensitive components (e.g., photo-detectors) to be properly exposed to sunlight. For example, sun sensor assembly 10 could be coated with an encapsulating coating (not shown), and/or as discussed below in connection with FIGS. 6-9, sun sensor assembly 10 can be positioned within the volume of trough concentrator 150 and covered with cover 152.

One or more sun sensor assemblies according to the present invention may be combined with additional component(s) in a manner such that the one or more sun sensor assemblies can detect the position of the sun and help the additional component(s) track the position of the sun. Such additional components include one or more optical concentrators (e.g., solar trough concentrators) and the like. Solar concentrators are well known. See, e.g., U.S. Pub. Nos. 2006/0283497 (Hines) and 2007/0193620 (Hines et al.), the entireties of said publications being incorporated herein by reference. For example, two sun sensor assemblies 10 are used to help one or more solar concentrators 150 track the position of the sun. Two sun sensor assemblies 10 are preferably used because each sun sensor assembly 10 includes only one wide angle sensor 30 which includes only one photo-detector 42. To coarsely track the sun, two photo-detectors 42 (from two sun sensor assemblies 10) are preferably positioned in a manner so as to generate a differential signal for coarsely tracking the sun. One narrow angle sensor 30 already includes two photo-detectors 66 and 68 for generating a differential signal so as to finely track the sun.

As shown in FIGS. 6-9, trough concentrator 150 includes a concentrator portion 153, end caps 154 and 156, transparent cover 152, and two sun sensor assemblies 10 positioned inside the volume of trough concentrator 150, preferably in a manner that does not obstruct the active regions of trough concentrator 150. By arranging two sun sensor assemblies 10 on opposite ends of the same trough 150 or on opposite ends of two separate troughs in the same panel full sky coverage may be achieved allowing one or the other narrow angle sensor to see the sun year round. Additionally, the arrangement in trough concentrator 150 orients each wide angle sensor 30 in opposite directions so as to form a field of view of 180 degrees and that is able to cover the entire sky. As shown in FIGS. 7A and 7B, a sun sensor assembly 10 is attached to feature 170 of trough end cap 154. As shown in FIG. 7A, feature 170 is angled such that the field of view of sun sensor assembly 10 on trough end cap 154 along the non-tracking axis includes an angle θ₁₆₆. Similarly, the field of view of sun sensor assembly 10 on trough end cap 156 along the non-tracking axis includes an angle θ₁₆₈. In preferred embodiments, as shown in FIG. 7B, feature 170 on the end cap 154 clips sun sensor assembly 10 into position. Feature 170 allows “snap-in-place assembly”, which can save on manufacturing and assembly costs.

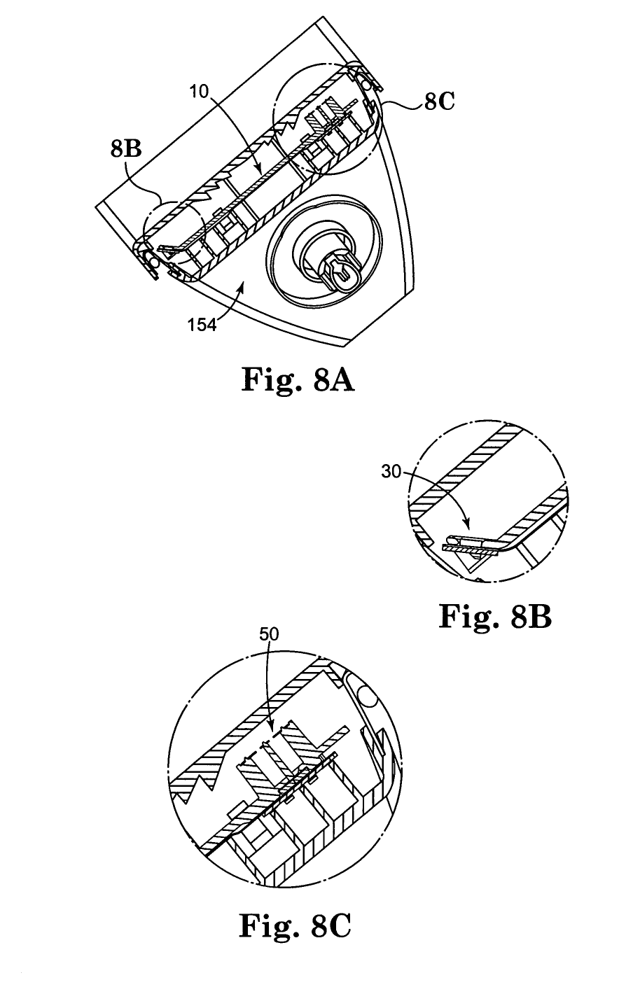

FIGS. 8A-8C provide additional views of the end cap 154 and sun sensor assembly 10 detailing the location of the narrow angle sensor 50 and the wide angle sensor 30.

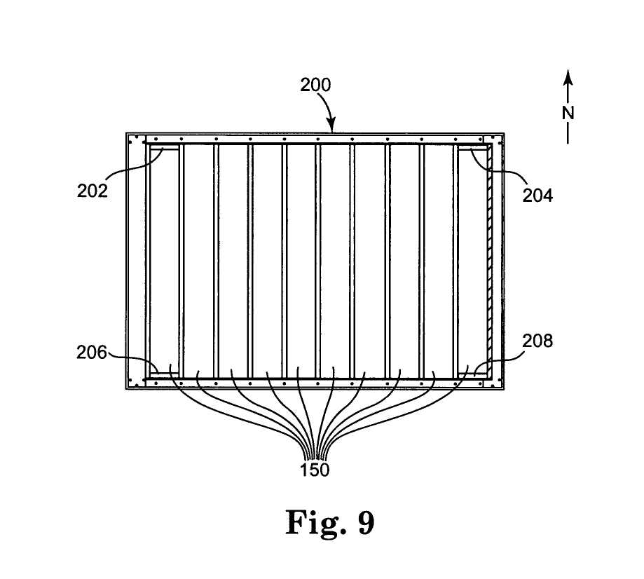

FIG. 9 shows a contemplated embodiment including a concentrating solar panel 200, which includes a plurality of concentrating troughs 150. In one embodiment, sun sensor assemblies 10 may be located at positions 202 and 208. Such an arrangement results in a panel 200 that may be rotated 180 degrees without affecting sun tracker orientation. It should be noted that the same could be achieved by placing sun sensor assemblies 10 in similar symmetric locations including but not limited to 204 and 206. In another embodiment, sun sensor assemblies 10 may be located at positions 202 and 208 and two additional sun sensor assemblies (not shown) having only wide angle sensors 30 may be located at positions 204 and 206. Such an arrangement provides a redundant wide angle sensor pair, thereby reducing the sun tracker sensitivity to shadowing of sensors. In addition, such an arrangement results in a panel 200 that may be rotated 180 degrees without affecting sun tracker orientation.

Aforementioned contemplated embodiments of a sun sensor assembly according to the present invention provide a mechanism by which the sun position may be measured relative to the sun sensor assembly along one axis. Alternative embodiments can provide a mechanism by which the sun position may be measured relative to the sun sensor assembly along two orthogonal axes. For example, one such embodiment (not shown) arranges two sun sensor assembles 10 along orthogonal axes so that each sun sensor assembly 10 provides a separate measurement. In another embodiment (not shown), a single sun sensor assembly includes two narrow angle sensors 50 arranged orthogonal to each other and two wide angle sensors 30 arranged orthogonal to each other.

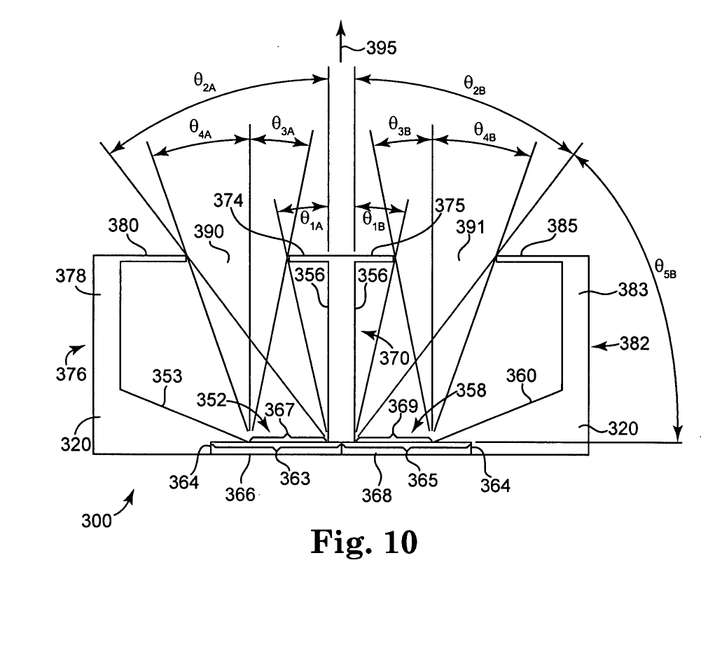

FIG. 10 shows an alternative narrow angle sun sensor 300 according to the present invention in cross-section. Narrow angle sensor 300 includes base 320, apertures 352 and 358, photo-detectors 366 and 368, blinders 370, 376, and 382, and slits 390 and 391. Narrow angle sensor 300 is functionally similar to narrow angle sensor 50, described above, however as described below most of the structure of narrow angle sensor 300 is a unitary integral piece. Such an integral structure is preferred as it relatively easy to manufacture in high volume and at low cost, while at the same time providing a narrow angle sensor with a high degree of accuracy.

Base 320 includes sloping shoulders 353 and 360. Blinder 370 includes wall 356 and ledges 374 and 375. Sloping shoulder 353 and wall 356 help define aperture 352. Aperture 352 defines an area that is less than the photo-detecting surface 363 of photo-detector 366. As such, aperture 352 overlies photo-detecting surface 363 in a manner that defines active area window 367. In preferred embodiments, as shown, the area defined by aperture 352 is within the boundaries (i.e., does not touch the boundaries) of photo-detecting surface 363. Similarly, sloping shoulder 360 and 356 help define aperture 358. Aperture 358 defines an area that is less than the photo-detecting surface 365 of photo-detector 368. As such, aperture 358 overlies photo-detecting surface 365 in a manner that defines active area window 369. In preferred embodiments, as shown, the area defined by aperture 358 is within the boundaries (i.e., does not touch the boundaries) of photo-detecting surface 365.

Blinder 376 includes wall 378 and ledge 380. Blinder 382 includes wall 383 and ledge 385. Ledges 380 and 374 help define slit 390, and ledges 385 and 375 help define slit 391.

Base 320 and blinders 370, 376, and 382, form a unitary structure. In particular, it is noted that wall 378 and ledge 380 form a unitary structure, wall 356 and ledges 374 and 375 form a unitary structure, and wall 383 and ledge 385 form a unitary structure. In contrast, the ledges 74/75, 80, and 85, of narrow angle sensor 50 do not form a unitary structure with walls 56, 78, and 83, respectively. Instead, ledges 74/75, 80, and 85, are part of a separate structure (i.e., mask 88).

Forming base 320 and blinders 370, 376, and 382, into a unitary structure can be made by well-known methods such as molding (e.g., injection molding) and can be made out of well-known materials such as plastic and the like.

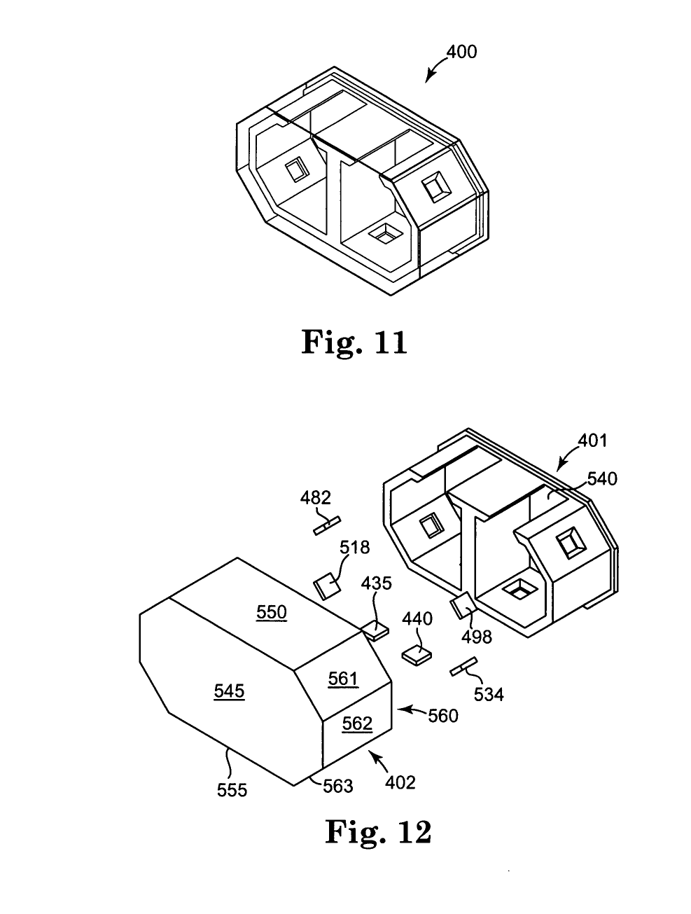

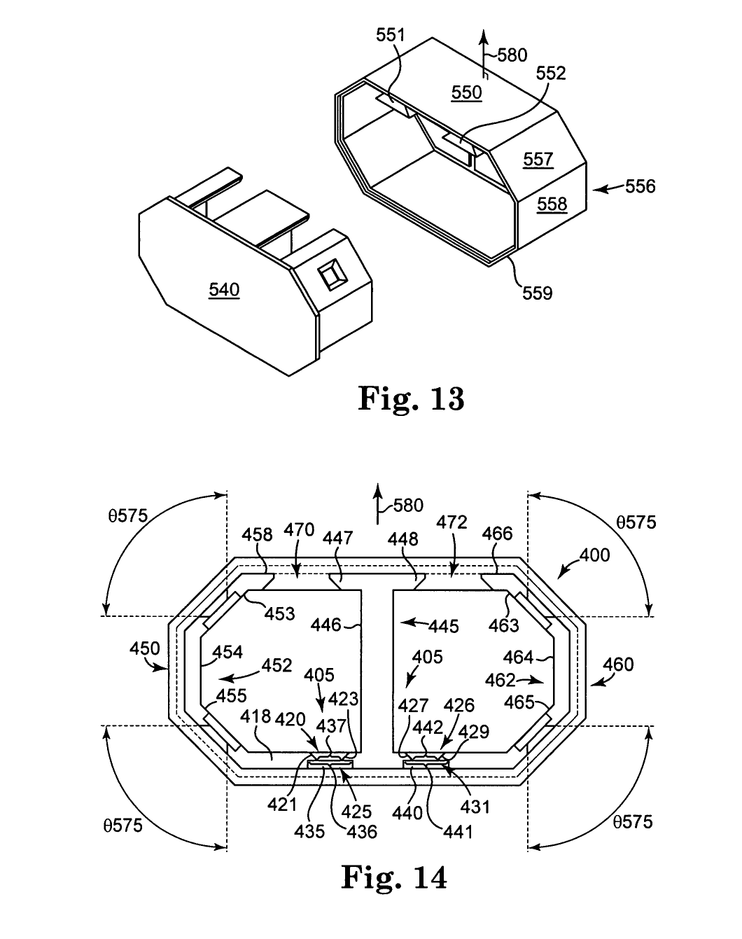

FIGS. 11-16F show an alternative sun sensor assembly 400 according to the present invention. Sun sensor assembly 400 includes a first part 401 and a second part 402. First part 401 provides mounting structure for multiple photo-detectors and second part 402 is a cover that is oversized relative to first part 401 in a manner such that cover 402 can slide together and mate with first part 401.

First part 401 includes narrow angle sensor 405, and four wide angle sensors 410, 412, 414, and 416.

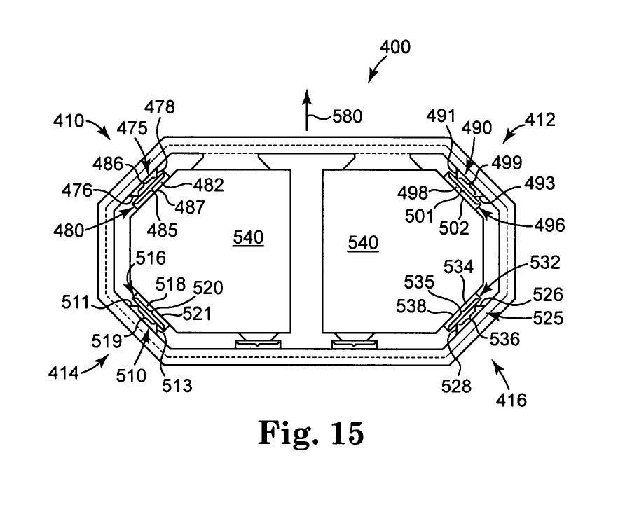

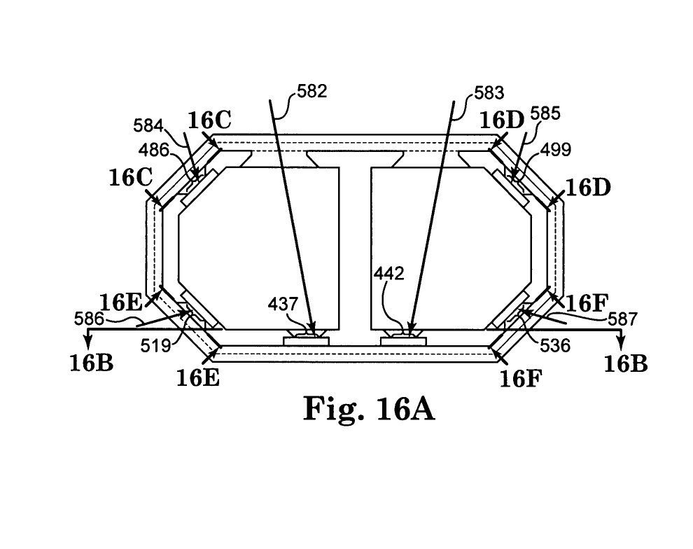

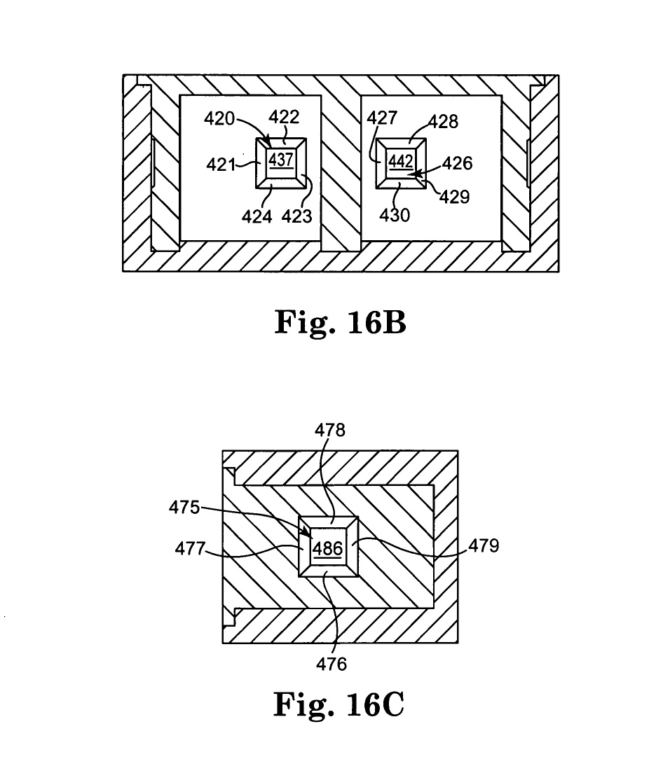

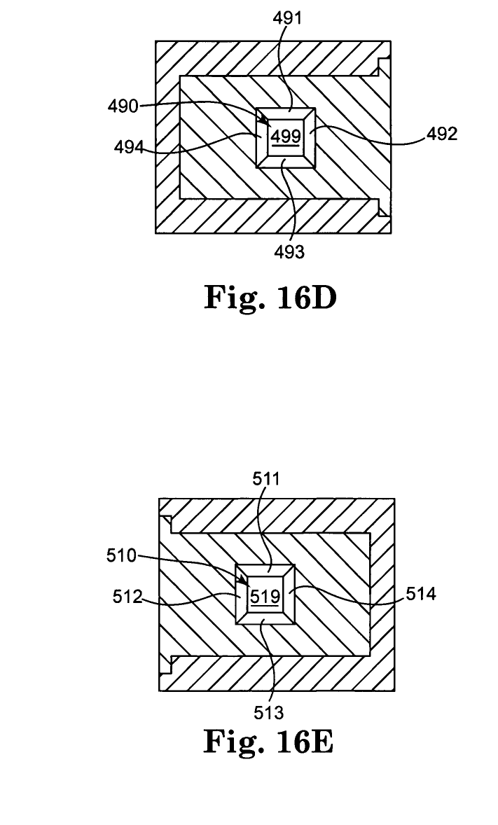

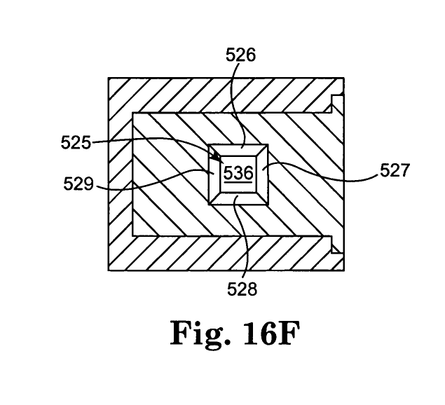

Narrow angle sensor 405 includes base 418, photo-detectors 435 and 440, blinders 445, 450, and 460, and slits 470 and 471. Base 418 includes apertures 420 and 426, and slots 425 and 431. In a manner similar to apertures 52 and 58, apertures 420 and 426 are openings through which light can pass and illuminate photo-detectors 435 and 440, respectively, so that photo-detectors 435 and 440 can be used to help sun sensor assembly 400 finely track the sun. For example, as shown in FIGS. 14 and 16B, aperture 420 is defined by sloping shoulders 421, 422, 423, and 424, and aperture 426 is defined by sloping shoulders 427, 428, 429, and 430. Slot 425 provides structure to support photo-detector 435 and is positioned in a manner so as to register photo-detector 435 with respect to aperture 420. Slot 431 provides structure to support photo-detector 440 and is positioned in a manner so as to register photo-detector 440 with respect to aperture 426. As can be seen FIG. 14, aperture 420 defines an area that is less than the area of photo-detecting surface 436 of the photo-detector 435 such that when photo-detector 435 is positioned in slot 425, aperture 420 overlies the photo-detecting surface 436 so that a portion 437 of the photo-detecting surface 436 can be exposed to incident sunlight. The portion 437 of the photo-detecting surface 436 that can be exposed to incident sunlight is also referred to “active area window” 437. For example, as shown in FIG. 16A, incident sunlight 582 can be detected by active area window 437. In preferred embodiments, as shown, the area defined by aperture 420 is within the boundaries (i.e., does not touch the boundaries) of photo-detecting surface 436. In a similar manner, aperture 426 defines an area that is less than the area of photo-detecting surface 441 of the photo-detector 440 such that when photo-detector 440 is positioned in slot 431, aperture 426 overlies the photo-detecting surface 441 so that a portion 442 of the photo-detecting surface 441 can be exposed to incident sunlight. The portion 442 of the photo-detecting surface 441 that can be exposed to incident sunlight is also referred to “active area window” 442. For example, as shown in FIG. 16A, incident sunlight 583 can be detected by active area window 442. In preferred embodiments, as shown, the area defined by aperture 426 is within the boundaries (i.e., does not touch the boundaries) of photo-detecting surface 441.

Advantageously, using apertures 420 and 426 and slots 425 and 431, respectively, together so as to define active area windows 437 and 442, respectively, allows sun sensor assembly 400 to be mass produced at low cost, while at the same time maintaining a high level of precision and accuracy for concentrating solar collectors and systems. For example, photo-detectors 435 and 440 may have variations in the diameters of photo-detecting surfaces 436 and 441, respectively, due to manufacturing tolerances. Undue variation among the diameters of photo-detectors during mass production of a sun sensor can cause variation in the distance from a photo-detector center to other sensor features (e.g., one or more of walls 446, 452, and 462), which can reduce the pointing accuracy of a narrow angle sensor. However, using apertures 420 and 426 that are sufficiently under-sized relative to the photo-detecting surfaces 436 and 441, respectively, active area windows 437 and 442, respectively, can be defined that provide consistent/uniform positioning of windows 437 and 442 among multiple sun sensor assemblies 400 that are mass produced. Apertures 420 and 426 are preferably positioned relative to other sun sensor features in a uniform manner among sun sensor assemblies that are mass produced (e.g., within a lot of sun sensor assemblies and/or among lot to lot of sun sensor assemblies), especially sun sensor features that impact the pointing accuracy of the sun sensor (e.g., one or more of walls 446, 452, and 462).

Blinders 445, 450, and 460, help define the field of view of narrow angle sensor 405. As shown, narrow angle sensor 405 has a field of view of +/−15 degrees. Blinder 445 includes wall 446 and ledges 447 and 448. Blinder 450 includes wall 452 and ledge 458. Wall 452 includes an upper angled portion 453, a middle portion 454, and a lower angled portion 455. Upper portion 453 and lower portion 455 are positioned at an angle of 45 degrees relative to normal 580. Blinder 460 includes wall 462 and ledge 466. Wall 462 includes an upper angled portion 463, a middle portion 464, and a lower angled portion 465. Upper portion 463 and lower portion 465 are positioned at an angle of 45 degrees relative to normal 580.

As can be seen in cross-section, slit 470 is formed at least in part by ledges 458 and 447, and slit 472 is formed at least in part by ledges 466 and 448.

Wide angle sensors 410, 412, 414, and 416 are positioned on walls 452 and 262 in a manner to provide sun sensor assembly 400 with a field of view suitable for coarsely tracking the sun. Preferably, as shown, wide angle sensors 410, 412, 414, and 416, are positioned on upper wall portion 453, upper wall portion 463, lower wall portion 455, and lower wall portion 465, respectively. As shown in FIGS. 14, 15, and 16A, wall portions 453, 463, 455, and 465, are positioned at an angle of 45 degrees relative to normal 580. As shown in FIG. 14, each wide angle sensor 410, 412, 414, and 416, has a field of view of θ₅₇₅ which is +/−60 degrees (i.e., 120 degrees). Advantageously, such an arrangement provides sun sensor assembly 400 with a 360 degree field of view for coarsely tracking the sun. As another advantage, a single sun sensor assembly 400 includes wide angle sensors 410, 412, 414, and 416, such that a single sun sensor assembly 400 can generate a differential signal for coarsely tracking the sun using any well-known tracking method.

In more detail, wide angle sensor 410 includes aperture 475 in upper wall portion 453, slot 480, and photo-detector 482. Aperture 475 is an opening through which light can pass and illuminate photo-detector 482 so that photo-detector 482 can be used to help sun sensor assembly 400 coarsely track the sun. For example, as shown in FIGS. 15 and 16C, aperture 475 is defined by sloping shoulders 476, 477, 478, and 479. Slot 480 provides structure to support photo-detector 482. Photo-detector 482 can be held in place by any suitable method of fastening (e.g., one or more of clips, adhesives, and the like). Slot 480 is positioned in a manner so as to register photo-detector 482 with respect to aperture 475 and define an “active area window” 486. As can be seen in FIG. 15, aperture 475 defines an area that is less than the area of photo-detecting surface 485 of the photo-detector 482 such that when photo-detector 482 is positioned in slot 480, aperture 475 overlies the photo-detecting surface 485 so that a portion 486 of the photo-detecting surface 485 can be exposed to incident sunlight. The portion 486 of the photo-detecting surface 485 that can be exposed to incident sunlight is also referred to “active area window” 486. For example, as shown in FIG. 16A, incident sunlight 584 can be detected by active area window 486. In preferred embodiments, as shown, the area defined by aperture 475 is within the boundaries (i.e., does not touch the boundaries) of photo-detecting surface 485. Also in preferred embodiments, as shown, photo-detector 482 has an opaque backside 487 so as to not detect radiation from the backside and potentially provide an erroneous signal with respect to the position of the sun.

Wide angle sensor 412 includes aperture 490 in upper wall portion 463, slot 496, and photo-detector 498. Aperture 490 is an opening through which light can pass and illuminate photo-detector 498 so that photo-detector 498 can be used to help sun sensor assembly 400 coarsely track the sun. For example, as shown in FIGS. 15 and 16D, aperture 490 is defined by sloping shoulders 491, 492, 493, and 494. Slot 496 provides structure to support photo-detector 498. Photo-detector 498 can be held in place by any suitable method of fastening (e.g., one or more of clips, adhesives, press fit, and the like). Slot 496 is positioned in a manner so as to register photo-detector 498 with respect to aperture 490 and define an “active area window” 499. As can be seen in FIG. 15, aperture 490 defines an area that is less than the area of photo-detecting surface 501 of the photo-detector 498 such that when photo-detector 498 is positioned in slot 496, aperture 490 overlies the photo-detecting surface 501 so that a portion 499 of the photo-detecting surface 501 can be exposed to incident sunlight. The portion 499 of the photo-detecting surface 501 that can be exposed to incident sunlight is also referred to “active area window” 499. For example, as shown in FIG. 16A, incident sunlight 585 can be detected by active area window 499. In preferred embodiments, as shown, the area defined by aperture 490 is within the boundaries (i.e., does not touch the boundaries) of photo-detecting surface 501. Also in preferred embodiments, as shown, photo-detector 498 has an opaque backside 502 so as to not detect radiation from the backside and potentially provide an erroneous signal with respect to the position of the sun.

Wide angle sensor 414 includes aperture 510 in lower wall portion 455, slot 516, and photo-detector 518. Aperture 510 is an opening through which light can pass and illuminate photo-detector 518 so that photo-detector 518 can be used to help sun sensor assembly 400 coarsely track the sun. For example, as shown in FIGS. 15 and 16E, aperture 510 is defined by sloping shoulders 511, 512, 513, and 514. Slot 516 provides structure to support photo-detector 518. Photo-detector 518 can be held in place by any suitable method of fastening (e.g., one or more of clips, adhesives, press fit, and the like). Slot 516 is positioned in a manner so as to register photo-detector 518 with respect to aperture 510 and define an “active area window” 519. As can be seen in FIG. 15, aperture 510 defines an area that is less than the area of photo-detecting surface 520 of the photo-detector 518 such that when photo-detector 518 is positioned in slot 516, aperture 510 overlies the photo-detecting surface 520 so that a portion 519 of the photo-detecting surface 520 can be exposed to incident sunlight. The portion 519 of the photo-detecting surface 520 that can be exposed to incident sunlight is also referred to “active area window” 519. For example, as shown in FIG. 16A, incident sunlight 586 can be detected by active area window 519. In preferred embodiments, as shown, the area defined by aperture 510 is within the boundaries (i.e., does not touch the boundaries) of photo-detecting surface 520. Also in preferred embodiments, as shown, photo-detector 518 has an opaque backside 521 so as to not detect radiation from the backside and potentially provide an erroneous signal with respect to the position of the sun.

Wide angle sensor 416 includes aperture 525 in lower wall portion 465, slot 532, and photo-detector 534. Aperture 525 is an opening through which light can pass and illuminate photo-detector 534 so that photo-detector 534 can be used to help sun sensor assembly 400 coarsely track the sun. For example, as shown in FIGS. 15 and 16F, aperture 525 is defined by sloping shoulders 526, 527, 528, and 529. Slot 532 provides structure to support photo-detector 534. Photo-detector 534 can be held in place by any suitable method of fastening (e.g., one or more of clips, adhesives, press fit, and the like). Slot 532 is positioned in a manner so as to register photo-detector 534 with respect to aperture 525 and define an “active area window” 536. As can be seen in FIG. 15, aperture 525 defines an area that is less than the area of photo-detecting surface 535 of the photo-detector 534 such that when photo-detector 534 is positioned in slot 532, aperture 525 overlies the photo-detecting surface 535 so that a portion 536 of the photo-detecting surface 535 can be exposed to incident sunlight. The portion 536 of the photo-detecting surface 535 that can be exposed to incident sunlight is also referred to “active area window” 536. For example, as shown in FIG. 16A, incident sunlight 587 can be detected by active area window 536. In preferred embodiments, as shown, the area defined by aperture 525 is within the boundaries (i.e., does not touch the boundaries) of photo-detecting surface 535. In preferred embodiments, as shown, photo-detector 534 has an opaque backside 538 so as to not detect radiation from the backside and potentially provide an erroneous signal with respect to the position of the sun.

As shown, first part 401 has a side wall 540 that attaches to blinders 445, 450, and 460. Preferably, side wall 540 forms a unitary structure with blinders 445, 450, and 460. In preferred embodiments, side wall 540 is opaque so as to prevent radiation from entering sun sensor assembly 400 and reducing the field of view of narrow angle sensor 405 in an undue manner.

As mentioned, second part 402 can slide together and mate with first part 401. Second part 402 can be fastened to first part 401 in any suitable manner. In preferred embodiments, second part 402 is releasably fastened to first part 401 via spring clips (not shown) or the like. Second part 402 functions as a cover to protect first part 401 from the elements such as rain, debris, and the like. Second part 402 is transparent at least to the extent so that second part 402 does not interfere with sunlight being incident upon one or more photo-detectors 435, 440, 482, 498, 518, and 534, as described above. Preferably, second part 402 is a unitary structure.

As shown, second part 402 includes side wall 545, top 550, bottom 555, wall 556, and wall 560. In more detail, top portion 550 includes mating portions 551 and 552. Mating portion 551 slidingly mates with slit 470 and mating portion 552 sliding mates with slit 472 so as to help register first portion 401 with second portion 402. Wall 556 includes an upper angled portion 557, a middle portion 558, and a lower angled portion 559. Upper portion 557 and lower portion 559 are positioned at an angle of 45 degrees relative to normal 580. Wall 560 includes an upper angled portion 561, a middle portion 562, and a lower angled portion 563. Upper portion 561 and lower portion 563 are positioned at an angle of 45 degrees relative to normal 580.

As mentioned, contemplated embodiments of a sun sensor assembly according to the present invention provide a mechanism by which the sun position may be measured relative to the sun sensor assembly. Such a measurement is in the form of photocurrents proportional to the amount of incident light on each photo-detector. In order for sun tracking to occur, these photocurrents must be used by a control system to effect articulation of the sun sensor assemblies so as to orient sun sensor assemblies toward the sun.

In general, methods of sun tracking are well known. However, methods related to sun tracking have been discovered that are useful with any kind of sun sensor assembly, especially sun sensor assemblies described herein (e.g., sun sensor assemblies 10 and/or 400).

A method of sun tracking has been discovered that includes common signal processing chains. Advantageously, common signal processing chains can minimize sensor errors resulting from component mismatches, thermal drift, and/or drift associated with component lifetime.

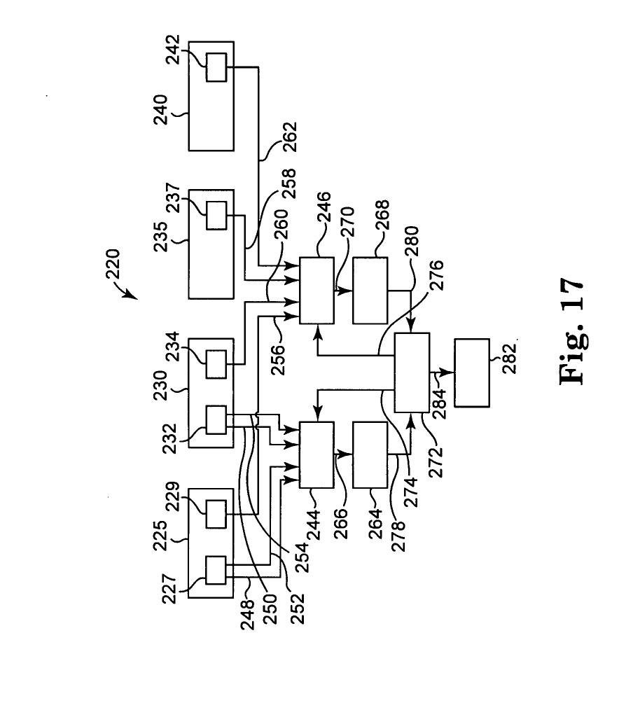

FIG. 17 helps illustrate a method of sun tracking that includes common signal processing chains. FIG. 17 shows a block diagram 220 in connection with a contemplated method for sun tracking that uses four sun sensor assemblies 225, 230, 235, and 240, two analog multiplexers 244 and 246, two detection circuits 264 and 268, and a microprocessor 272. As indicated in diagram 220, sun sensor assemblies 225 and 230 have narrow angle sensors 227 and 232, respectively, and wide angle sensors 229 and 234, respectively, whereas the remaining two sun sensor assemblies 235 and 240 have only wide angle sensors 237 and 242, respectively. Each narrow angle sensor 227 and 232 generates a pair of signals 248/252 and 250/254, respectively, where each signal is proportional to the intensity of the light falling on a corresponding photo-detector (not shown), respectively. These four signals 248, 250, 252, and 254, are connected to an analog multiplexer 244 that is used to select one of these signals and pass the selected signal 266 to detection circuit 264. The signal selection is controlled by microprocessor 272 as indicated by signal 274. The detection circuit 264 conditions the selected signal so that the conditioned signal 278 can be used as an input to microprocessor 272. As the detection circuit 264 is common to all narrow angle sensors 227 and 232, bias sources such as component mismatch (e.g., if signals 248, 250, 252, and 254, were each processed by individual detection circuits that were mismatched), thermal drift, and lifetime drift that would affect methods using individual circuits for each photo-detector are advantageously eliminated.

A similar method can be used for wide angle sensors 229, 234, 237, and 242. Each of wide angle sensors 229, 234, 237, and 242, provides one half of the information needed to perform wide angle (i.e., coarse) pointing with respect to the entire sky. As such, two of these sensors 229 and 237 are oriented in the same direction and generate signals 256 and 258, respectively, that correspond to the light intensity falling on the photo-detectors (not shown) of wide angle sensors 229 and 237, respectively. The remaining two sensors 234 and 242 are oriented in the same direction which is opposite to the direction that sensors 229 and 237 are oriented in. In a similar manner, sensors 234 and 242 generate signals 260 and 262, respectively, that corresponds to the light intensity falling on the photo-detectors (not shown) of wide angle sensors 234 and 242, respectively. Wide angle sensors 229 and 234 together provide a field of view of 180 degrees. Wide angle sensors 237 and 242 together provide the same (i.e., redundant) field of view of 180 degrees as wide angle sensors 229 and 234. Having two redundant pairs of wide angle sensors (229/234 and 237/242) advantageously decreases sensitivity to shadowing. The four signals 256, 258, 260, and 262, are connected to analog multiplexer 246 which selects one of these signals and passes the selected signal 270 to detection circuit 268. Signal selection is controlled by microprocessor 272 as indicated by signal 276. The detection circuit 268 conditions the selected signal so that conditioned signal 280 may be used as an input to microprocessor 272. As the detection circuit 268 is common to all wide angle sensors 229, 234, 237, and 242, bias sources such as component mismatch (e.g., if signals 256, 258, 260, and 262 were each processed by individual detection circuits that were mismatched), thermal drift, and lifetime drift that would affect methods using individual circuits for each photo-detector are eliminated.

In an alternative embodiment, the two wide angle sensor only assemblies 235 and 240 in the aforementioned method are replaced by sensor assemblies similar to 225 and 230, which have both wide angle and narrow angle sensors. Such additional narrow angle sensors provide additional redundancy.

In another alternative embodiment, analog multiplexers 244 and 246 are replaced by a single multiplexer (not shown) so that all photo-detectors share a common multiplexer and detection circuits 264 and 268 are replaced by a single detection circuit (not shown) so that all photo-detectors share a common detection circuit.

Optionally, microprocessor 272 periodically samples narrow and wide angle sensor inputs, calibrates the raw sensor data, determines sensor data validity, computes error signals, and effects articulation of the sun sensor assemblies 225, 230, 235, and 240, by sending control signal 284 to articulation subsystem 282.

Contemplated tracking methods also include microprocessor-based control systems to perform intelligent tracking functions such as self-calibration and sensor selection.

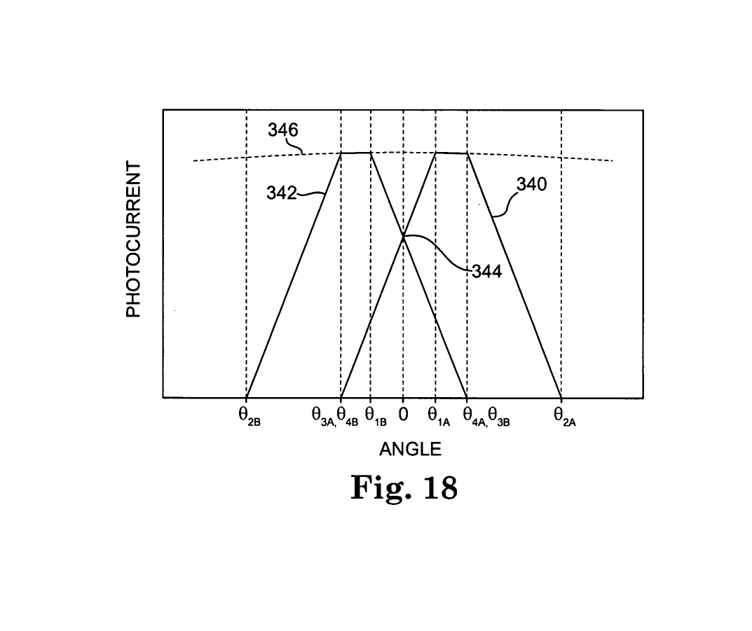

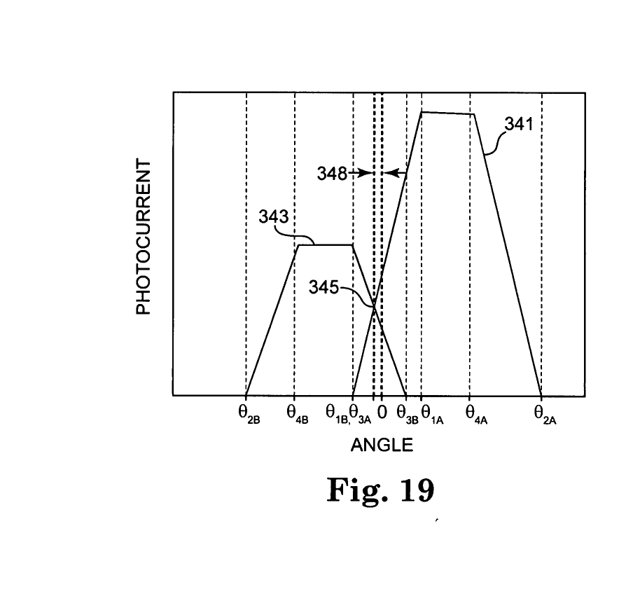

Tracking accuracy depends on the sensitivity, repeatability, and accuracy of the sun sensor apparatus, in particular the narrow angle sensor. FIGS. 18 and 19 will be used to describe sensing errors that may occur by referring to the narrow angle sensor illustrated in FIG. 10. The following description will characterize quantities associated with photo-detector 366 with the suffix ‘A’ and those associated with photo-detector 368 with the suffix ‘B’. Each photo-detector 366 and 368 generates a photocurrent proportional to the amount of light incident on the detector. FIG. 10 illustrates several cutoff angles that affect the light that is incident upon and detected by photo-detectors 366 and 368. FIG. 18 plots the photocurrent versus angle for an idealized case in which the photo-detectors 366 and 368 are matched perfectly and the narrow angle sensor 300 is symmetric. Light within angle θ_{5B} is not incident upon either photo-detector 366 or 368. Between angles θ_{2B} and θ_{4B} light increasingly falls on photo-detector 368. Between angles θ_{4B} and θ_{1B} the intensity of light detected by photo-detector 368 follows the cosine law for non-normal incidence and is characterized by curve 346 in FIG. 18. Between angles θ_{1B} and θ_{3B} the intensity of light detected by photo-detector 368 decreases as blinder 370 shades photo-detector 368. At angles greater than angle θ_{3B}, photo-detector 368 is fully shaded by blinder 370. As shown in FIG. 18, photo-current 340 generated by photo-detector 366 is symmetric to the photo-current 342 generated by photo-detector 368. Tracking the sun involves maintaining the sun sensor 300 so that the incident light is zero degrees relative to the narrow angle sensor axis 395. This condition ideally occurs when the photo-currents 340 and 342 are equal as indicated by point 344. In practice, however, photo-detectors are oftentimes mismatched (e.g., have different conversion gain) and a narrow angle sensor may not be perfectly symmetric. Such mismatching and/or asymmetry can cause sensing error. Left uncorrected, sensing error reduces the accuracy of sun tracking. FIG. 19 illustrates an example of sensing error when photo-detectors 366 and 368 have a different conversion gain. As shown in FIG. 19, photo-current 341 generated by photo-detector 366 is asymmetric to the photo-current 343 generated by photo-detector 368. In this case, the point 345 where photo-current 341 and 343 are equal does not correspond to incident light being zero degrees relative to the narrow angle sensor axis 395; rather, incident light being zero degrees relative to the narrow angle sensor axis 395 is displaced by the sensing error 348.

Correcting sensing errors (e.g., such as sensing error 348) can be achieved via calibration methods disclosed herein, preferably self-calibration methods. Self-calibration methods refer to methods by which, e.g., a sun tracking subsystem may make sun sensor measurements to determine correction factors autonomously in the field. Self-calibration methods can be contrasted to calibration methods that are performed pre-deployment and cannot be updated without outside intervention e.g. by a technician, etc. Advantages to self-calibration methods include the ability to re-calibrate, the ability to correct errors associated with thermal and/or lifetime drift, and the elimination of external apparatus to perform calibration function.

Contemplated self-calibration methods generally consist of a method to measure sensing errors associated with photo-detector mismatch and a method to measure sensing errors associated with narrow angle sensor asymmetries. In some contemplated methods, one or the other sub-method may be used. Error sources associated with photo-detectors include dark current bias Id, and gain k. The photocurrent as a function of intensity for each photo-diode is given by the following equations:

i_{A}=k_{A}I+I_{dA}

i_{B}=k_{B}I+I_{dB}

The resulting sensing error between detectors is therefore:

ε=i_{A}−i_{B}=(k_{A}−k_{B})I+I_{dA}−I_{dB}

For applications like sun tracking that have relatively high light intensities, variations in dark current bias contribute negligibly to the error. Gain variations, however, may contribute significantly to the sensing error. It can be shown that the detector gain is proportional to the slope of the measured photocurrent about the track point (e.g., line 341 in FIG. 19). In contemplated self-calibration methods, these gains may be measured by making measurements sweeps about the un-calibrated track point and determining the slopes, preferably using linear regression calculations. These measured slopes are then applied to sensor measurements when tracking to correct for gain errors.

Contemplated methods for calibrating structural asymmetries in the narrow angle sensor rely on the cosine law stating that the intensity of incident light on a planar surface is proportional to the cosine of the angle the light makes relative to the plane's normal vector.

I(θ)=I₀ cos(θ)

Because no absolute angle is known for a given photocurrent measurement, a given set of photo-current measurements of the form:

{(θ₀,i₀), (θ₀+Δ,i₁), (θ₀+2Δ,i₂), . . . , (θ₀+nΔ,iₙ)},

made over the range θ_{1A}-θ_{4A} may be fitted to a cosine function of form:

i(θ)=kI₀ cos(θ−φ_{A}), where

ø is angular distance between θ₀ and 0.

Given a relative measurement of the non-calibrated track point (e.g., point 345 in FIG. 19), θ₀+m Δ, the sensor error due to sensor asymmetries is given by:

ε_{θA}=φ_{A}−mΔ

### A similar computation of the relative angular error may be made for the other photo-detector.

Combining previously measured photo-detector gain factors k_{A} and k_{B} with the angle errors ε_{A} and ε_{B}, a calibrated photocurrent measurement may be computed as:

$${i}_{cA} = \frac{{k}_{B}}{{k}_{A}} ( {i}_{A} ) - {k}_{A} {ɛ}_{θ A}$$

$$and , \\ {i}_{cB} = \frac{{k}_{A}}{{k}_{B}} ( {i}_{B} ) - {k}_{B} {ɛ}_{θ B}$$

where i_{A} and i_{B} are the non-calibrated photocurrents.

In another contemplated method, measurements of wide angle sensor photo-detectors are fitted to a cosine and correlated to the non-calibrated track point of the narrow angle sensor in order to compute the angle errors of the narrow angle sensor. This method has the advantage of a much wider range of angles over which the cosine law is applicable. In yet another contemplated method, measurements of either the narrow angle sensors or wide angle sensors are fitted to a polynomial approximation of the cosine law.

Thus, specific embodiments and applications of sensor systems and apparatus, methods of production and uses thereof have been disclosed. It should be apparent, however, to those skilled in the art that many more modifications besides those already described are possible without departing from the inventive concepts herein.

What is claimed is:

1. A sun sensor assembly comprising:
a) a first photo-detector and a second photo-detector, wherein each photo-detector has a photo-detecting surface,
b) a base having a first surface, wherein the first surface of the base comprises a first aperture and a second aperture, wherein the first aperture defines an area that is less than the area of the photo-detecting surface of the first photo-detector and the second aperture defines an area that is less than the area of the photo-detecting surface of the second photo-detector, and wherein the first photo-detector is positioned in a manner such that the first aperture overlies the photo-detecting surface of the first photo-detector in a manner so as to expose a portion of the photo-detecting surface to incident sun-light and the second photo-detector is positioned in a manner such that the second aperture overlies the photo-detecting surface of the second photo-detector in a manner so as to expose a portion of the photo-detecting surface to incident sun-light; and
c) a light blocking member positioned on the first surface of the base in a manner that allows an illumination source to differentially illuminate the first and second photo-detectors as a function of the angle between the illumination source and a normal vector of the photo-detecting surfaces.

2. The sun sensor assembly of claim 1, wherein the first aperture defines an area that is within the boundaries of the photo-detecting surface of the first photo-detector and the second aperture defines an area that is within the boundaries of the photo-detecting surface of the second photo-detector.

3. The sun sensor assembly of claim 1, wherein the light blocking member comprises a first and second ledge, wherein the first ledge is positioned on the light blocking member in a manner such that the first ledge shades a portion of the first photo-detector when the first photo-detector is pointed directly at the sun, and wherein the second ledge is positioned on the light blocking member in a manner such that the second ledge shades a portion of the second photo-detector when the second photo-detector is pointed directly at the sun, wherein the amount of shade cast by the first and second ledges is substantially equal when the first and second photo-detectors are pointed directly at the sun.

4. The sun sensor assembly of claim 3, wherein the light blocking member is a first light blocking member, and further comprising second and third light blocking members, wherein the second light blocking member is positioned on the base in a manner to reduce the field of view of the first photo-detector and the third light blocking member is positioned on the base in a manner to reduce the field of view of the second photo-detector.

5. The sun sensor assembly of claim 4, wherein the second light blocking member further comprises a ledge that is positioned on second light blocking member in a manner that reduces the field of view of the first photo-detector and wherein the third light blocking member further comprises a ledge that is positioned on third light blocking member in a manner that reduces the field of view of the second photo-detector.

6. The sun sensor assembly of claim 5, wherein the base and first, second, and third light blocking members form a unitary structure.

7. The sun sensor assembly of claim 4, wherein the combined field of view of the first and second photo-detectors is +/−20 degrees.

8. The sun sensor assembly of claim 4, wherein the combined field of view of the first and second photo-detectors is +/−15 degrees.

9. The sun sensor assembly of claim 4, wherein the combined field of view of the first and second photo-detectors is +/−10 degrees.

10. The sun sensor assembly of claim 1, further comprising at least one additional photo-detector positioned on the base in a manner such that the at least one additional photo-detector has a field of view of at least +/−45 degrees.

11. The sun sensor assembly of claim 1, further comprising four additional photo-detectors positioned on the sun sensor assembly in a manner such that each additional photo-detector has a field of view of at least +/−45 degrees and such that the sun sensor assembly has a field of view of 360 degrees.

12. The sun sensor assembly of claim 1, wherein the base and light blocking member form a unitary structure.

13. A solar concentrator comprising at least two sun sensor assemblies mounted on the concentrator in a manner to help the solar concentrator track the sun, wherein the at least two sun sensor assemblies each comprise:
a) a first photo-detector and a second photo-detector, wherein each photo-detector has a photo-detecting surface,
b) a base having a first surface, wherein the first surface of the base comprises a first aperture and a second aperture, and wherein the first photo-detector is positioned in a manner such that the first aperture overlies the photo-detecting surface of the first photo-detector in a manner so as to expose a portion of the photo-detecting surface to incident sun-light and the second photo-detector is positioned in a manner such that the second aperture overlies the photo-detecting surface of the second photo-detector in a manner so as to expose a portion of the photo-detecting surface to incident sun-light; and
c) a light blocking member positioned on the first surface of the base in a manner that allows an illumination source to differentially illuminate the first and second photo-detectors as a function of the angle between the illumination source and a normal vector of the photo-detecting surfaces.

14. The solar concentrator of claim 13, wherein the at least two sun sensor assemblies are positioned orthogonally to each other.

15. The solar concentrator of claim 13, wherein each of the at least two sun sensor assemblies further comprise at least one additional photo-detector positioned on the base in a manner such that the at least one additional photo-detector has a field of view of at least +/−45 degrees.

16. The solar concentrator of claim 13, further comprising two additional sun sensor assemblies mounted on the concentrator in a manner to help the solar concentrator track the sun, wherein each additional sun sensor assembly comprises:
a) a base; and
b) at least one photo-detector positioned on the base in a manner such that the photo-detector has a field of view of at least +/−45 degrees.

17. A method of processing electrical signals from two or more photo-detectors comprising:
a) providing two or more photo-detectors, wherein each photo-detector generates an electrical signal indicative of the amount of incident light upon the photo-detector;
b) selecting one electrical signal from among the electrical signals generated by the two or more photo-detectors; and
c) conditioning the selected electrical signal in a manner so as to provide an unbiased electrical signal.

18. The method of claim 17, wherein two photo-detectors are pointed in the same direction with respect to the sun.

19. The method of claim 17, further comprising the steps of:
a) sending the conditioned signal to a microprocessor; and
b) causing the microprocessor to use the conditioned signal to control articulation of one or more solar concentrators.

20. A sun tracking system comprising:
a) a solar panel comprising:
i) a solar concentrator positioned on the solar panel in a manner sufficient to track the sun along an axis; and
ii) a sun sensor assembly positioned on the solar concentrator in a manner sufficient to track the sun along an axis, wherein the sun sensor assembly comprises at least two photo-detectors, wherein each photo-detector generates an electrical signal indicative of the amount of incident light upon each respective photo-detector;
b) a control system in electrical communication with the solar panel such that the control system can receive and send electrical signals in a manner to help the at least one solar concentrator track the sun, wherein the control system includes program instructions comprising:
i) selecting one electrical signal from among the electrical signals generated by the at least two photo-detectors; and
ii) conditioning the selected electrical signal in a manner so as to provide an unbiased electrical signal.
